(19) United States
(12) Patent Application Publication
(10) Pub. No.: US 2014/0161554 A1
(43) Pub. Date: Jun. 12, 2014

(54) Snowmobile Ski Tie Down Tray

(71) Applicant: Randy Ewasko, Cochrane (CA)

(72) Inventor: Randy Ewasko, Cochrane (CA)

(21) Appl. No.: 14/091,690

(22) Filed: Nov. 27, 2013

Related U.S. Application Data
(60) Provisional application No. 61/730,317, filed on Nov. 27, 2012.

(51) Int. Cl. B60P 3/06

(52) U.S. Cl. CPC B60P 3/062
USPC 410/2

(57) ABSTRACT

A snowmobile tie down assembly is provided that is adapted to be secured to the bed of a hauling vehicle and support the skis of the snowmobile during transport. The assembly comprises a set of trays having a base surface and a pair of lateral side wall flanges. Extending from the flanges is a fastener strap that is adapted to be positioned over the base surface when attached and securing the ski of a snowmobile thereon. The base surface is fastened to the bed of the vehicle, wherein two of the trays are contemplated for secure the first and second ski of a snowmobile. The base surface may include a protective ski glide material layer thereon, while the fastener strap is preferably a separable ladder strap and buckle.

### CROSS REFERENCE TO RELATED APPLICATION

This application claims the benefit of U.S. Provisional Application No. 61/730,317 filed on Nov. 27, 2012, entitled “Snowmobile Tie Down.” The above identified patent application is herein incorporated by reference in its entirety to provide continuity of disclosure.

### BACKGROUND OF THE INVENTION

1. FIELD OF THE INVENTION

The present invention relates to a snowmobile. More particularly, the present invention pertains to a snowmobile tie down that secures the snowmobile skis in position for transport.

A snowmobile is a land vehicle designed for winter travel on snow and ice. Snowmobiles are used on a variety of terrains, including frozen lakes, open fields, and on wooded trails. Snowmobiles function in a manner similar to motorcycles and an all-terrain vehicles, in that they provide a mode of transportation that is more compact and in an open air configuration that is particularly enjoyable. Snowmobiles are unique in that they are particularly suited for wintery weather and use in snow, while motorcycles and larger automobiles may otherwise have difficult navigating such terrain, particularly in an off-road environment. Snowmobiles are provided track and motive power through the snow and ice by way of a continuous track at the rear thereof, driven by an onboard engine, while a pair of skis is provided along the front of the snowmobile to provide directional control thereof.

Snowmobiles were originally intended for use as a winter utility vehicle, with the intent of operating in locations that are unreachable by conventional motor vehicles. Snowmobiles found early acceptance and use by hunters and workers transporting personnel and material across snow-covered land, frozen lakes and rivers. In recent times, snowmobiles have become popular for recreational purposes. The growth in popularity has caused widespread use of snowmobiles in a variety of locations. This often necessitates that users transport their snowmobile to a desired location. Because this may require extended travel across roads that are not snow covered, many people will carry their snowmobile on a trailer on in the bed of a pickup truck, which requires a means of tying the vehicle down for safe transport.

The present invention provides a snowmobile tie-down when transporting a snowmobile using another vehicle from one location to another. The device comprises a pair of trays that are secured to the forward skis that are each secured by independent strap fasteners. The trays protect the skis during transport by preventing direct contact and rubbing against the floor or cargo bed of the transport vehicle, while also retaining the position of each ski in a static position. The tray can be removably mounted to a trailer, truck deck, or truck box, wherein the strap fastener secures the skis of the snowmobile thereto to prevent motion of the snowmobile and excessive rubbing against the vehicle surface. The fastener may comprise a ladder strap, a wire latch with cam buckle, or a similar means of securing two separable strap members across the tray. The snowmobile is positioned such that the strap is secured over the skis thereof. Overall, the device secures each ski independently during transportation, thereby preventing movement or damage thereto.

### DESCRIPTION OF THE PRIOR ART

Devices have been disclosed in the prior art that relate to snowmobile tie down assemblies and trailer assemblies. These include devices that have been patented and published in patent application publications, and generally relate to larger assemblies that are installed onto a trailer for securing the skis of a snowmobile during transport. These devices range in complexity and sophistication; however none anticipate the securable trays of the present invention. The following is a list of devices deemed most relevant to the present disclosure, which are herein described for the purposes of highlighting and differentiating the unique aspects of the present invention, and further highlighting the drawbacks existing in the prior art.

One such device in the prior art is U.S. Pat. No. 5,044,845 to Baker, Jr., which discloses a snowmobile transport platform having a plurality of pairs of spaced forward slots and a plurality of rear slots aligned therewith. An underlying platform that is pivotably attached below the platform and biased thereto supports an actuator arm extending through the forward slots and a hook member extending through the rear slots. The hook member engages a latch rod positioned over a pair of snowmobile skis, while a spring pulls the hook member against the platform and the actuator arm acts as a means to release the hook. This assembly, while providing a removably attached securing means for the skis of a snowmobile along a trailer platform, requires a specific trailer vehicle or modification to an existing trailer to operate. The present invention contemplates simple ski trays upon which to secure the forward skis thereto, wherein a first and second independent ski tray is provided to secure each ski of the snowmobile.

U.S. Pat. No. 5,902,081 to Zizzi discloses a locking system for securing the ski or skis of a snowmobile to a platform, wherein a stationary shaft is secured to the platform and includes an adjustment means for clamping a snowmobile ski between a lock bar and the platform. An adjustment nut and crank handle are utilized to adjust the lock bar with respect to the platform. Once the lock bar is sufficiently clamping the ski, the ski will not readily move from its clamped position during transport. This assembly, while less complicated than the Baker, Jr. device and requiring a less intensive installation procedure on the platform, does not anticipate the individual ski of the present invention or the fastening strap extending from the sides thereof.

U.S. Pat. No. 6,164,882 to Selle discloses a tie-down mechanism for snowmobile skis that contemplates a trailer itself having an elongated channel within which a bolt tie down and ski bar mechanism is slidably placed. The ski bar clamps the skis of a snowmobile against the trailer using an elongated bolt and a pivotably lever that draws the head of the bolt against the ski bar and sandwiches the skis therebetween. The Selle device is a clamping mechanism, wherein the present invention contemplates a strap fastener connection means that retains each of the snowmobile skis within an open tray device. The tray is secured to any trailer type or cargo area suitable for supporting the length of the snowmobile, wherein the tray may also incorporate a ski glide surface thereon to protect the ski edges.

U.S. Pat. No. 6,099,218 to Ferrari discloses a snowmobile ski hold down assembly along a trailer that comprises a pair of upstanding hold down brackets fixed to the bed of a trailer. The brackets accept hold down rods therethrough, which are used to secure the snowmobile struts of the snowmobile skis. The Ferrari device comprises a pair of upstanding bracket members that include rods that cross over the top of the skis, wherein the brackets are secured opposite one another along the sides of the snowmobile. The present invention contemplates a removably attached tray that includes upstanding flange members, wherein the entire assembly is a unified structure and is deployed under each snowmobile ski. The Ferrari device secures the ski struts along a fore and aft side, while the present invention clamps directly to the skis themselves.

Finally, U.S. Pat. No. 3,786,950 to Zemien discloses an attachment for a trailer that is adapted to support the trailing ends of snowmobile skis using an inclined trailer bed and a pair of ramp members. The ramp members comprised an inclined portion and a drop-off that abuts against the trailing ends of the snowmobile skis. The skis are slid over the inclined portion until the trailing ends are secured against the drop-off, whereafter the incline of the overall trailer and supporting trailer straps are utilized to secure the snowmobile to the trailer. The Zemien device, while disclosing individually and removably attached members to a trailer that secure the individual skis of a snowmobile, the mode in which these device secure the skis diverges significantly from the present invention. The present invention does not rely on the use of an inclined trailer, but contemplates individual trays and fastener straps to secure a snowmobile ski thereto. To prevent sliding, the fastener straps are securely fastened to each ski, while the base surface of the tray may further incorporate ski glide or a similar protective layer.

The present invention relates to a pair of tray assemblies that support the first and second ski of a snowmobile from below and include a fastener strap thereover. The trays are fastened to the cargo area of a trailer or truck vehicle, whereafter the snowmobile skis are each positioned over their respective trays and secured thereto using the fastener straps. The trays may include a protective base surface to facilitate ease of positioning and to prevent dulling or damaging of the snowmobile skis while supported thereon. It is submitted that the present invention is substantially divergent in design elements from the prior art, and consequently it is clear that there is a need in the art for an improvement to existing snowmobile tie down devices. In this regard the instant invention substantially fulfills these needs.

### SUMMARY OF THE INVENTION

In view of the foregoing disadvantages inherent in the known types of snowmobile tie down devices now present in the prior art, the present invention provides a new tie down tray that can be utilized for providing convenience for the user when securing the individual skis of a snowmobile using independent tie downs secured to the cargo area of a transport vehicle.

It is therefore an object of the present invention to provide a new and improved snowmobile tie down device that has all of the advantages of the prior art and none of the disadvantages.

It is another object of the present invention to provide a snowmobile tie down device that comprises a pair of forward ski trays that accept the skis of a snowmobile therein and secure each with a fastener strap, wherein the snowmobile is retained by the set of trays during transport.

Another object of the present invention is to provide a snowmobile tie down device that does not require a specific trailer type or extensive modifications to a trailer or cargo area in order to install and deploy the device.

Yet another object of the present invention is to provide a snowmobile tie down device that comprises an open tray having a base surface that may be covered with a protective material to prevent damage to the ski edges or the steel runner thereof during transport.

Another object of the present invention is to provide a snowmobile tie down device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a view of the snowmobile tie down device of the present invention with the strap fastener in an open and unfastened configuration.

FIG. 2 shows a view of the snowmobile tie down device with the strap fastener in a fastened configuration.

FIG. 3 shows the snowmobile tie down device in a working state, attached to a conventional snowmobile ski.

FIG. 4 shows a view of an embodiment of the present invention, in which the base surface of the tie down device includes a protective, ski glide material thereover.

### DETAILED DESCRIPTION OF THE INVENTION

Reference is made herein to the attached drawings. Like reference numerals are used throughout the drawings to depict like or similar elements of the snowmobile tie down device of the present invention. For the purposes of presenting a brief and clear description of the present invention, the preferred embodiment will be discussed as used for securing the skis of a snowmobile during transport using a set of tray assemblies attached to the cargo area of a transport vehicle. The figures are intended for representative purposes only and should not be considered to be limiting in any respect.

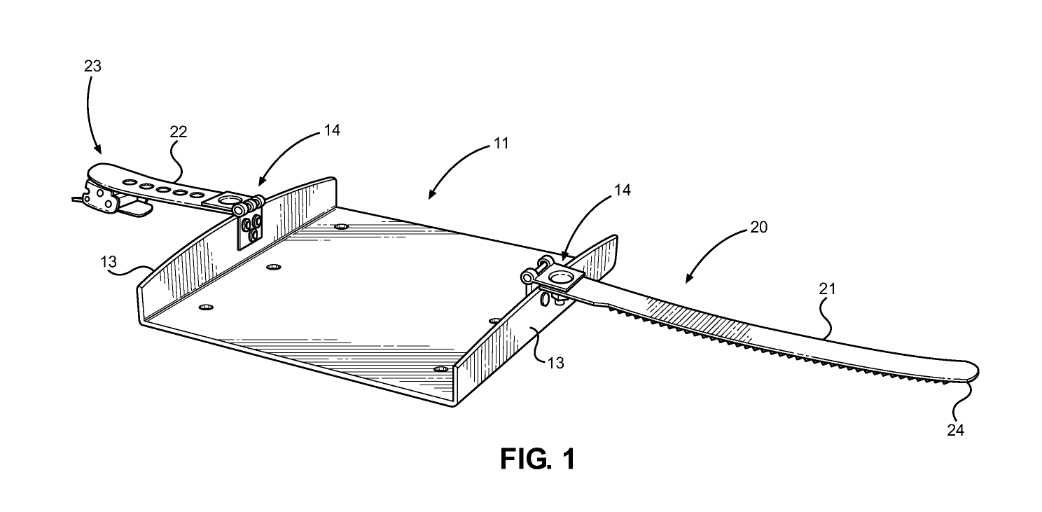

The present invention is a snowmobile ski tie down assembly that contemplates a pair of ski securing trays, wherein each tray secures an individual ski of the snowmobile to a trailer vehicle and prevents the same from sliding during transport. Referring now to FIG. 1, there is shown a perspective view of the ski securing tray 11 of the present invention in an open, unfastened configuration. The tray 11 comprises an elongated base surface 12 that is adapted to support a portion of a snowmobile ski thereon and accommodate the width thereof, while a first and second sidewall flange 13 extends upwards from the sides of the tray 11. The flanges 13 prevent lateral movement of the ski within the tray 11 and further provide a connection point for the ends of a strap fastener 20 utilized to secure the ski to the base surface 12 of the tray 11.

The strap fastener 20 comprises a first strap length 21 and a second strap length 22 that are adapted to secure together over the tray base surface 12 and secure a ski therein. The strap lengths 21, 22 are hingedly attached to the upper portion of each flange 13 via a hinge connection 14. This allows the straps to be pivoted out of the way while positioning a ski within the tray 11 and then pivoted into a working state thereover. The end of the second strap length 22 comprises a buckle or similar strap securing and/or winching assembly 23 that is adapted to secure the first strap length 21 thereto. The end 24 of the first strap length 21 is accepted through the strap buckle 23 and drawn across the tray width when securing a ski within the tray 11. The strap fastener is preferably a ladder strap assembly having a ladder strap first length 21 and a second strap length 22 comprising a ladder strap buckle 23. Alternate contemplated fastener straps include a wire latch with cam buckle, a ratchet strap, and a standard belt buckle style strap attachment. It is not desired to limit the strap buckle type of the present invention, but rather to disclose a first and second strap length with a buckle adapted to join the two strap lengths together over the tray 11 while in use.

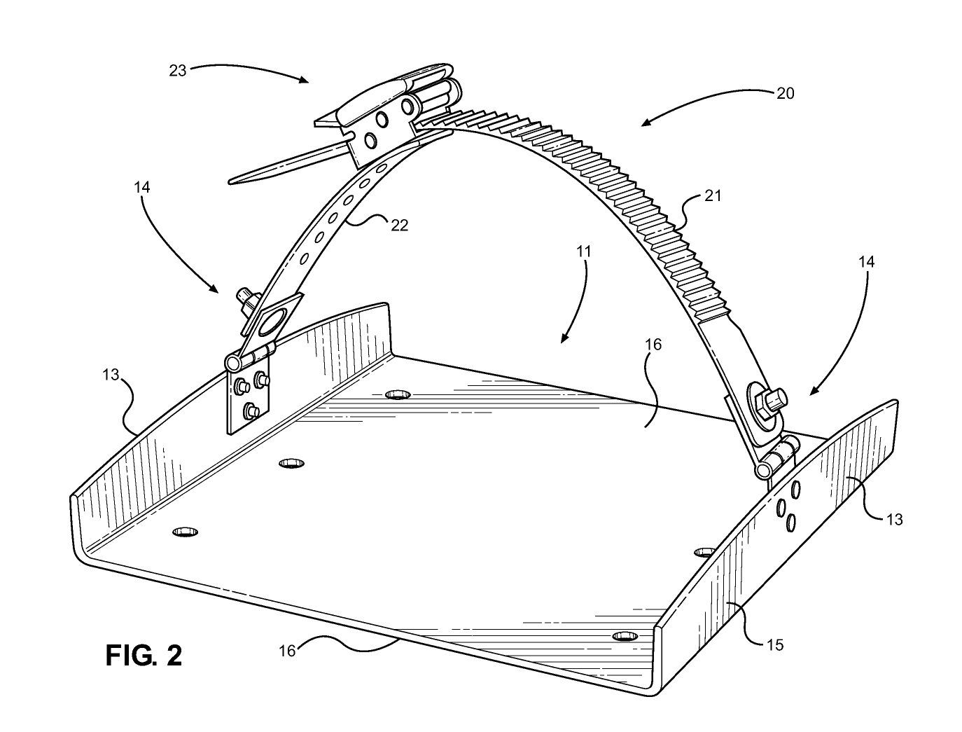

Referring now to FIG. 2, there is shown a view of the snowmobile tie down device of the present invention in a fastened configuration. The tray 11 is a formed or fabricated assembly having a U-shaped design, comprising a base surface 12 having an open first and second end 16 and a first and second side 15. The sides 15 form into or are attached to the upstanding flanges 13 of the device, where between the two flanges 13 contain the ski therebetween and on the base surface 13 of the tray during transport. To further secure the ski, the fastener strap lengths 21, 22 secure together via the strap buckle 23 over the ski and over the base surface 12. The fastener strap 20 preferably comprises a ratchet buckle design that enables the strap lengths to be adjustably tightened as needed between the flanges 13. The strap 20 is ratcheted or otherwise cinched into a taught position over the base surface 12 while transporting a snowmobile, and unfastened to release each ski.

The size of the tray 11 and the strap lengths enable the present invention to be secured to snowmobile skis of varying size, thereby ensuring a secure connection between the transporting vehicle and the snowmobile. The preferred configuration of the strap buckle and strap design is that of the ratchet strap configuration, which allows for single handed cinching and releasing, and further is well known to skiers and snowmobilers. The use of a ratchet strap design also allows users to fasten and unfasten the strap 20 even while wearing thick snow gloves. This is particularly beneficial for loading and unloading the snowmobile in colder climates and in snow conditions.

Each of the strap lengths 21, 22 are secured to a hinge joint 14, wherein the hinge joint 14 allows the strap lengths to be easily rotated over the base surface 12 or rotated out of the way during loading of a ski thereonto. The hinge joint 14 comprises a hardware element having an upper and lower connection point. The upper connection point secures to the first end of the strap length and the lower connection point secures to the tray flange 13. The joint positions the hinge rotation center above the flanges 13, wherein the strap flanges do not cause an interference during the rotation of the straps.

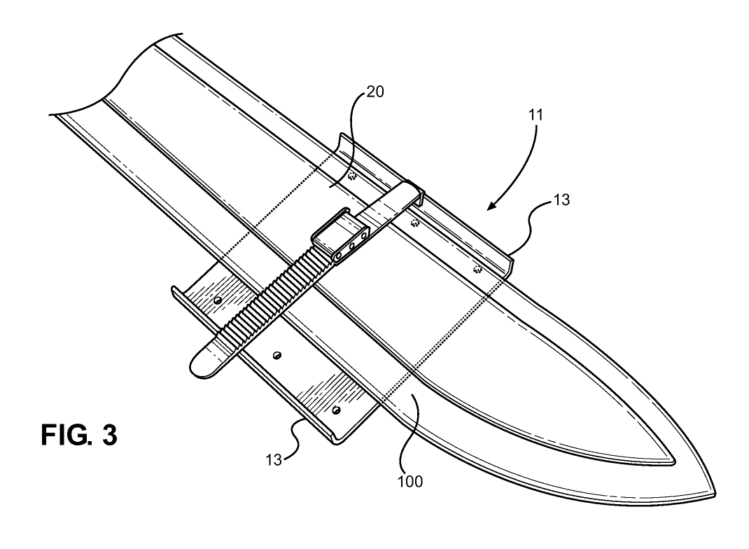

Referring now to FIG. 3, there is shown a view of the snowmobile tie down device in a working state, wherein a conventional snowmobile ski 100 is positioned within the interior of the tray 11 and secured therein. The fastener strap 20 is first unsecured as the ski 100 is positioned over the base surface of the tray 11. Once therein, the fastener strap 20 is secured thereover and cinched into place, securing the ski 100 between the flanges 13 and against the base surface of the tray or against a protective ski layer positioned thereon.

The tray 11 of the present invention can be mounted the cargo area of a trailer, truck bed, or box truck, wherein the tray 11 is fastened to the cargo area. The tray base surface comprises a plurality of fastener apertures that allow fasteners to be send therethrough to secure the tray 11 to the cargo area while in use. This retains their static position in the bed and ultimately the ski position within the cargo area. In use, a snowmobile is positioned at an appropriate position relative to a pair of trays 11 to allow the strap to secure the front of the ski and/or ski spindle to the base surface thereof. The trays 11 are spaced relative to one another to accommodate the front ski separation of the snowmobile, wherein the straps are provided with a sufficient length to secure over the skis and optionally the ski spindle area when securing the ski thereto. The fastener strap 20 crosses over the top of the ski in such a manner as to secure the snowmobiles ski between the tip of the ski and the ski spindle, firmly securing the ski 100 to the cargo area of the transport vehicle.

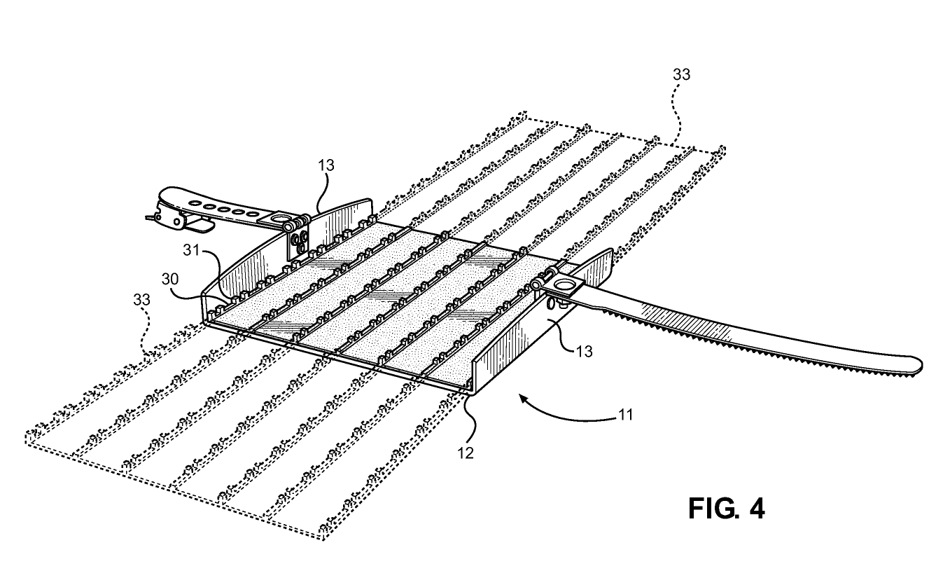

Referring now to FIG. 4, there is shown a view of an embodiment of the present invention that contemplates a protective layer over the tray 11 that allows the tray 11 to be suitable for supporting both the skis snowmobile. This embodiment contemplates a base surface 12 having a protective layer 30 that prevents damage to the edges of the snowmobile skis while supported within the trays 11. The protective layer 30 is coextensive with the base surface 12 of the tray 11 and provides a cushioned layer of rubber or elastomeric material that prevents hard contacts between the tray 11 and the snowmobile skis. This protective layer comprises a surface having a plurality of grooves 31 therealong, which are designed to reduce surface friction between the material and the snowmobile treads, while also facilitating smooth gliding of the snowmobile therealong when loading the same. The grooved protective material 30 may take on the form of standard snowmobile ski glide material, wherein the material is positioned on the base surface 12 of the tray 11, between the flanges 13 and from one end to the other.

As can be appreciated, ski glide material is a material designed to protect both snowmobile treads and the snowmobile skis from damage while unloading and loading a snowmobile in the trays for transport. In an embodiment of the protective material 30, the material (protective ski glide material, etc.) may extend outward 33 from the tray ends and be provided in an overly elongated fashion to support the entire length of each snowmobile ski contact patch. This extends the material along the ski entire length rather than limiting it to the tray dimensions.

Overall, the present invention is attached directly to the transport vehicle and can be deployed in a set of forward trays and a single rear tray. Forward trays support the snowmobile skis while the rear track is supported rearward in the cargo area. The fastener straps secure the skis into the independent trays, securing the snowmobile in two forward locations to prevent movement while in transport. The protective material further adds a means of preventing damage to the snowmobile while in transport while facilitating loading of the skis into the trays. The grooved material allows skis to slide smoothly therein, such that the user can smoothly position the skis into the forward pair of trays. The trays are removably fastened to the cargo area and do not require extensive modification of the area to deploy. Once the snowmobile is in position and the straps are positioned over the skis, the straps are incrementally cinched over the skis, which enables the device to be securely fastened to a variety of snowmobile makes and models. In this way, the present invention provides a secure and convenient way for safely transporting a snowmobile on a transporting vehicle.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention. I claim:

1. A snowmobile tie down device for securing the ski of a snowmobile therein, comprising:
a tray having a base surface, a first and second end, and a first and second side;
a first sidewall flange extending upwardly from said first side;
a second sidewall flange extending upwardly from said second side;
a strap fastener having a first strap length, a second strap length, and a strap securing assembly;
said first strap length securing to said first sidewall flange;
said second strap length securing to said second sidewall flange;
said strap securing assembly adapted to secure said first strap length and second strap length together over said base surface and between said first sidewall flange and second sidewall flange.

2. The snowmobile tie down device of claim 1, wherein:
said first strap length further comprises a ladder strap;
said strap securing assembly of said second strap length further comprises a ladder strap buckle.

3. The snowmobile tie down device of claim 1, further comprising:
a first hinge joint hingedly attaching said first strap length to said first sidewall flange;
a second hinge joint hingedly attaching said second strap length to said second sidewall flange.

4. The snowmobile tie down device of claim 1, wherein said first and second side of said base surface are separated by a distance adapted to be greater than a standard snowmobile ski width.

5. The snowmobile tie down device of claim 1, wherein said base surface further comprises a protective layer coextensive with said base surface.

6. The snowmobile tie down device of claim 5, wherein said protective layer comprises a grooved ski glide surface.

7. The snowmobile tie down device of claim 1, wherein said base surface further comprises a protective layer coextensive with said base surface and extends beyond said first and second end of said base surface.

8. The snowmobile tie down device of claim 7, wherein said protective layer comprises a grooved ski glide surface.

10. A snowmobile tie down assembly for securing the ski of a snowmobile therein, comprising:
a pair of forward trays and a rear tray, each having a base surface, a first and second end, and a first and second side;
a first sidewall flange extending upwardly from said first side;
a second sidewall flange extending upwardly from said second side;
a strap fastener having a first strap length, a second strap length, and a strap securing assembly;
said first strap length securing to said first sidewall flange;
said second strap length securing to said second sidewall flange;
said strap securing assembly adapted to secure said first strap length and second strap length together over said base surface and between said first sidewall flange and second sidewall flange;
said pair of forward trays adapted to support a snowmobile skis.

11. The snowmobile tie down assembly of claim 10, wherein:
said first strap length further comprises a ladder strap;
said strap securing assembly of said second strap length further comprises a ladder strap buckle.

12. The snowmobile tie down assembly of claim 10, further comprising:
a first hinge joint hingedly attaching said first strap length to said first sidewall flange;
a second hinge joint hingedly attaching said second strap length to said second sidewall flange.

13. The snowmobile tie down assembly of claim 10, wherein said first and second side of said base surface are separated by a distance adapted to be greater than a standard snowmobile ski width.

14. The snowmobile tie down assembly of claim 10, wherein said base surface further comprises a protective layer coextensive with said base surface.

15. The snowmobile tie down assembly of claim 14, wherein said protective layer comprises a grooved ski glide surface.

16. The snowmobile tie down assembly of claim 10, wherein said base surface further comprises a protective layer coextensive with said base surface and extends beyond said first and second end of said base surface.

17. The snowmobile tie down assembly of claim 16, wherein said protective layer comprises a grooved ski glide surface.
